(19) United States
(12) Patent Application Publication
(10) Pub. No.: US 2019/0049672 A1
(43) Pub. Date: Feb. 14, 2019

(54) FERRULE AND METHOD OF MANUFACTURING FERRULE

(71) Applicant: FUJITSU COMPONENT LIMITED, Tokyo (JP)

(72) Inventor: Kazuhiro Yoshida, Tokyo (JP)

(21) Appl. No.: 16/042,046

(22) Filed: Jul. 23, 2018

(30) Foreign Application Priority Data
Aug. 9, 2017 (JP) 2017-153981

(51) Int. Cl. G02B 6/38; G02B 6/32; G02B 6/42

(52) U.S. Cl. CPC G02B 6/3869; G02B 6/325; G02B 6/3853; G02B 6/4284; G02B 6/3861

(57) ABSTRACT

A ferrule includes a body and a lens part. The body includes a first connecting surface at which a slit for inserting an optical waveguide is open. The lens part includes a lens and a second connecting surface. The lens part is bonded to the body with an adhesive with the second connecting surface facing and contacting the first connecting surface. At least one of the first connecting surface and the second connecting surface includes a curved surface.

### CROSS-REFERENCE TO RELATED APPLICATION

The present application is based upon and claims priority to Japanese Patent Application No. 2017-153981, filed on Aug. 9, 2017, the entire contents of which are incorporated herein by reference.

### BACKGROUND OF THE INVENTION

### 1. Field of the Invention

The present invention relates to ferrules and methods of manufacturing a ferrule.

### 2. Description of the Related Art

Optical communications, which can increase a signal transmission rate and extend a transmission distance, are becoming popular as communications at high-speed interfaces of supercomputers and high-end servers.

For next-generation interfaces whose transmission distance is as long as several dozen meters, discussed in standards such as IBTA EDR (registered trademark) and 100G Ethernet (registered trademark), optical communications are employed and an optical module that connects, for example, an optical cable and a server is used. The optical module converts an optical signal from the optical cable into an electrical signal, and outputs the electrical signal to the server. The optical module also converts an electrical signal from the server into an optical signal, and outputs the optical signal to the optical cable.

The optical module includes a light-emitting device to convert an electrical signal into an optical signal, a light-receiving device to convert an optical signal into an electrical signal, a drive integrated circuit (IC) to drive the light-emitting device, and a transimpedance amplifier (TIA) to convert electric current into voltage. A flexible sheet-shaped optical waveguide is provided between the light-emitting and light-receiving elements and a ferrule such as a ferrule with lenses.

Reference may be made to Japanese Laid-open Patent Publication Nos. 2015-23143, 2015-22130, and 2013-20027 for related art.

### SUMMARY OF THE INVENTION

According to an aspect of the present invention, a ferrule includes a body and a lens part. The body includes a first connecting surface at which a slit for inserting an optical waveguide is open. The lens part includes a lens and a second connecting surface. The lens part is bonded to the body with an adhesive with the second connecting surface facing and contacting the first connecting surface. At least one of the first connecting surface and the second connecting surface includes a curved surface.

### BRIEF DESCRIPTION OF THE DRAWINGS

FIGS. 1A and 1B are diagrams illustrating a ferrule with lenses;

FIGS. 2A and 2B are diagrams illustrating the ferrule with lenses;

FIG. 3 is a diagram illustrating a structure of a ferrule according to a first embodiment;

FIGS. 4A through 4E are diagrams illustrating a structure of a body of the ferrule according to the first embodiment;

FIGS. 5A through 5E are diagrams illustrating a structure of a lens part of the ferrule according to the first embodiment;

FIG. 6 is a perspective view of the lens part according to the first embodiment;

FIGS. 7A and 7B are diagrams illustrating a structure of an optical waveguide;

FIG. 8 is a flowchart illustrating a method of manufacturing a ferrule according to the first embodiment;

FIGS. 9A through 9C are diagrams illustrating the method of manufacturing a ferrule according to the first embodiment;

FIGS. 10A through 100 are diagrams illustrating the method of manufacturing a ferrule according to the first embodiment;

FIGS. 11A through 11C are diagrams illustrating the method of manufacturing a ferrule according to the first embodiment;

FIG. 12 is a diagram illustrating the method of manufacturing a ferrule according to the first embodiment;

FIG. 13 is a diagram illustrating the method of manufacturing a ferrule according to the first embodiment;

FIGS. 14A and 14B are diagrams illustrating the method of manufacturing a ferrule according to the first embodiment;

FIG. 15 is a diagram illustrating the method of manufacturing a ferrule according to the first embodiment;

FIGS. 16A through 16E are diagrams illustrating a variation of the ferrule according to the first embodiment;

FIGS. 17A through 17E are diagrams illustrating a structure of a body of a ferrule according to a second embodiment; and

FIGS. 18A through 18E are diagrams illustrating a structure of a lens part of the ferrule according to the second embodiment.

### DESCRIPTION OF THE EMBODIMENTS

In optical modules, a sheet-shaped optical waveguide and a ferrule with lenses are bonded together with an adhesive. If the adhesive is cured, however, with air bubbles contained between an end face of the optical waveguide and the ferrule, desired characteristics cannot be obtained because of light attenuation due to the air bubbles.

Therefore, there is a demand for a ferrule that can be bonded to an optical waveguide without air bubbles between the ferrule and the optical waveguide.

A ferrule according to an embodiment can be bonded to an optical waveguide without entry of air bubbles between the ferrule and the optical waveguide, thus making it possible to prevent light attenuation.

Embodiments of the present invention are described below with reference to the accompanying drawings. The same members or components are referred to using the same reference numeral, and their description will not be repeated.

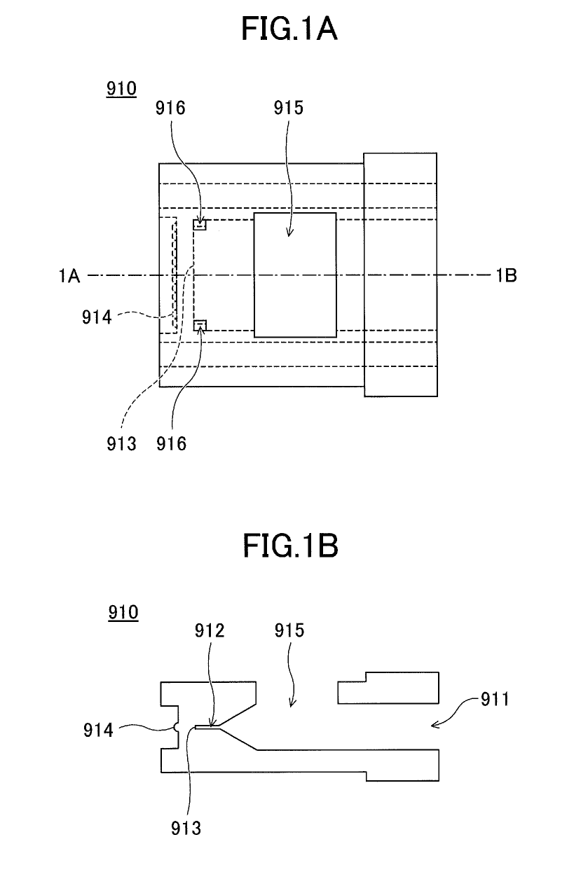

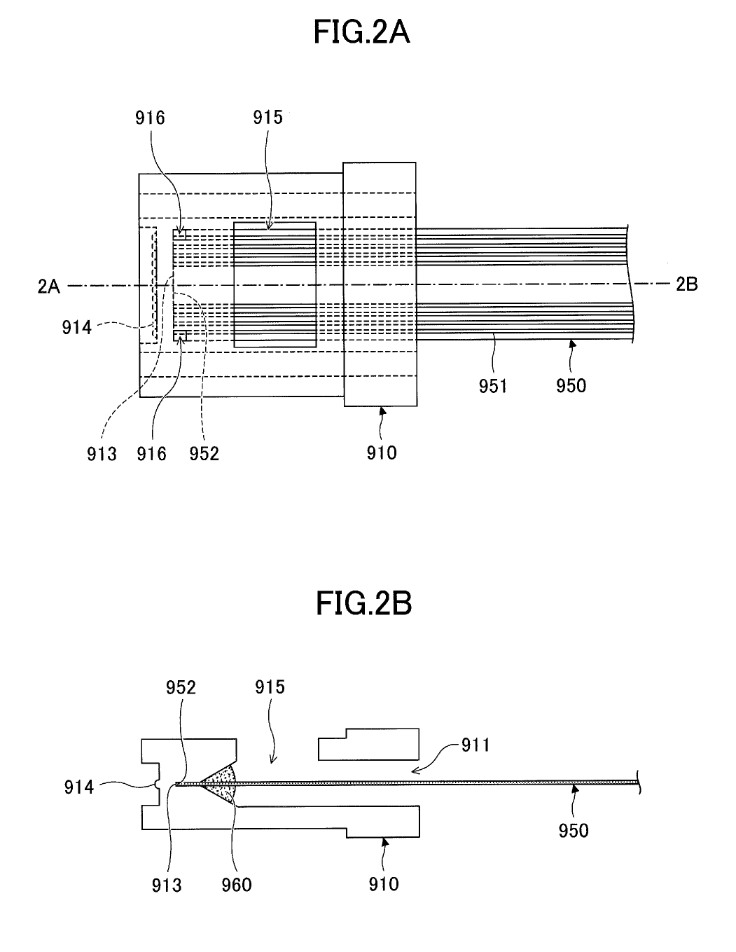

The bonding of a ferrule with lenses (hereinafter, “ferrule”) and an optical waveguide is described with reference to FIGS. 1A, 1B, 2A and 2B. FIG. 1A is a plan view of a ferrule 910, and FIG. 1B is a sectional view of the ferrule 910, taken along the one-dot chain line 1A-1B of FIG. 1A. FIG. 2A is a plan view of the ferrule 910 in which an optical waveguide 950 is inserted, and FIG. 2A is a sectional view of the ferrule 910 in which the optical waveguide 950 is inserted, taken along the one-dot chain line 2A-2B of FIG. 2A.

The ferrule 910 is formed of a light-transmitting resin material such as a cycloolefin polymer (COP). The sheet-shaped optical waveguide 950 is formed of a resin material, and includes cores 951 that propagate light and cladding that surround the cores 951.

The ferrule 910 has an opening 911 for inserting the optical waveguide 950. A slit 912 for placing an end face 952 of the optical waveguide 950 is provided at the bottom of the opening 911. The optical waveguide 950 is fixed to the ferrule 910 by an adhesive 960 such as an ultraviolet (UV) curable resin with the end face 952 placed in the slit 912.

A connecting surface 913 is formed at the very bottom of the slit 912. Multiple lenses 914 are provided on the extension line of the center of the slit 912 beyond the connecting surface 913. Furthermore, a window 915 is provided on the upper side of the opening 911, and air vent holes 916 are provided one at each transverse end of the connecting surface 913.

When bonding the optical waveguide 950 to the ferrule 910 with the adhesive 960, first, the adhesive 960 is supplied into the slit 912 through the window 915, and the optical waveguide 950 is thereafter inserted through the opening 911 with the end face 952 facing toward the slit 912 until the end face 952 contacts the connecting surface 913 at the bottom of the slit 912.

At this point, air intervening between the connecting surface 913 and the end face 952 is pushed out by the adhesive 960, and most of the adhesive 960 escapes through the air vent holes 916, while a thin layer of the adhesive 960 remains between the end face 952 and the connecting surface 913.

During application of the adhesive 960, bubbles may be generated in the adhesive 960. Furthermore, bubbles may be generated in the adhesive 960 as the adhesive 960 flows when moving the end face 952 toward the bottom of the slit 912. When the adhesive 960 is cured with such bubbles generated in the adhesive 960 remaining between the connecting surface 913 and the end face 952, the bubbles remain between the connecting surface 913 and the end face 952.

Light propagating through the cores 951 of the optical waveguide 950 exits from the end face 952 to enter the connecting surface 913, and after being transmitted through the ferrule 910, is condensed by the lenses 914 to exit from the lenses 914. Furthermore, light entering the ferrule 910 is transmitted through the ferrule 910 to exit from the connecting surface 913, and enters the cores 951 of the optical waveguide 950.

If air bubbles are present in the adhesive 960 between the connecting surface 913 and the end face 952, light is reflected or changes its travel direction at the interface between the cured adhesive 960 and the air bubbles, thus causing light attenuation to degrade characteristics.

Therefore, there is a demand for a ferrule that can be bonded to an optical waveguide without generation of air bubbles in an adhesive.

### First Embodiment

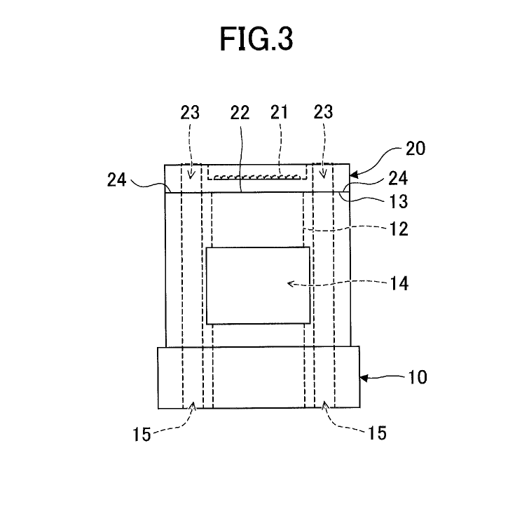

Next, a ferrule according to a first embodiment is described. Referring to FIG. 3, the ferrule of this embodiment includes a body 10 and a lens part 20.

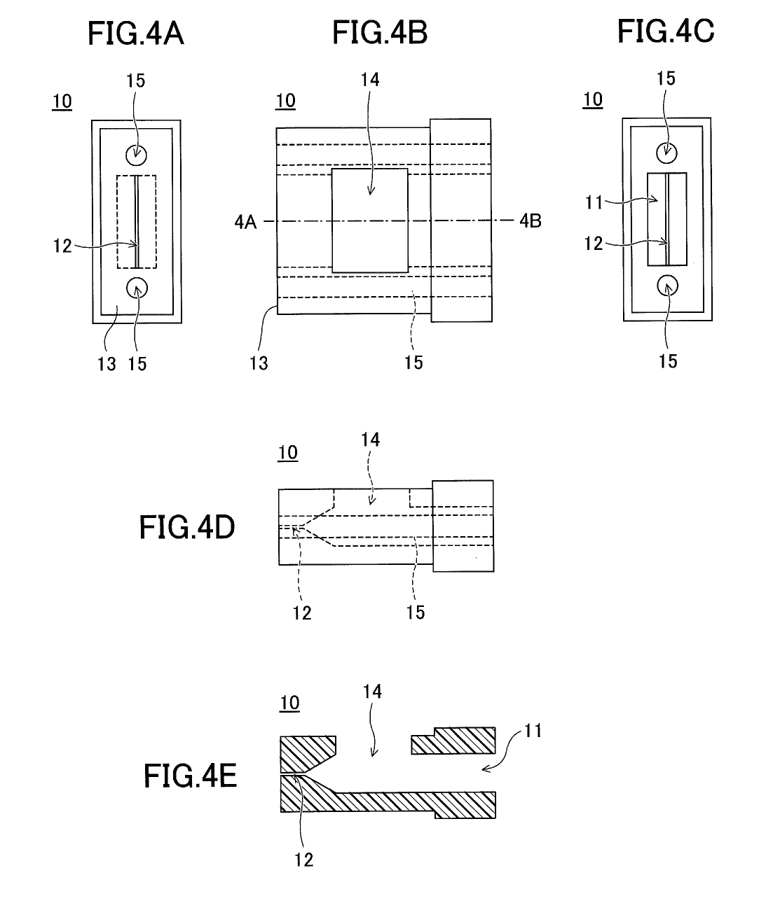

FIGS. 4A, 4B, 4C and 4D are a front view, a plan view, a rear view and a side view, respectively, of the body 10. FIG. 4E is a sectional view of the body 10, taken along the one-dot chain line 4A-4B of FIG. 4B.

The body 10 is formed by molding a resin material using a mold.

An opening 11 for inserting an optical waveguide is provided in the body 10. A slit 12 for placing an end face of the optical waveguide is provided at the bottom of the opening 11. The body 10 includes a connecting surface 13 that connects to the lens part 20, and the slit 12 pierces through the body 10 to the connecting surface 13. A window 14 for supplying an adhesive is formed through an upper surface of the body 10. Two guide pin holes 15 pierce through the body 10 in a longitudinal direction of the body 10 from the connecting surface 13. According to this embodiment, the connecting surface 13 is a plane surface.

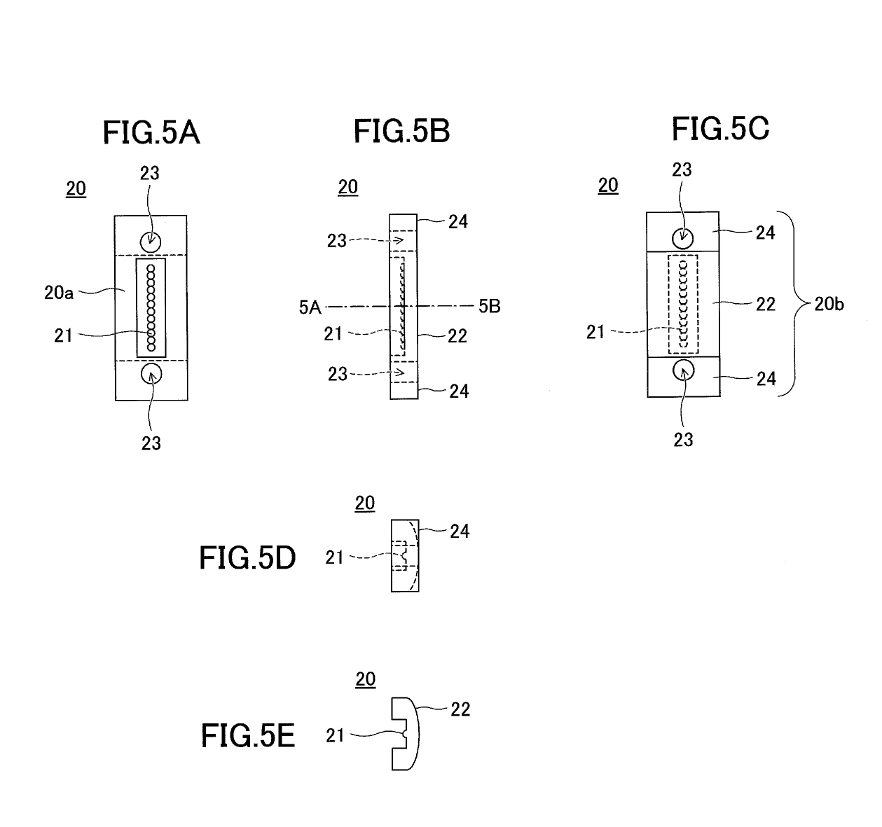

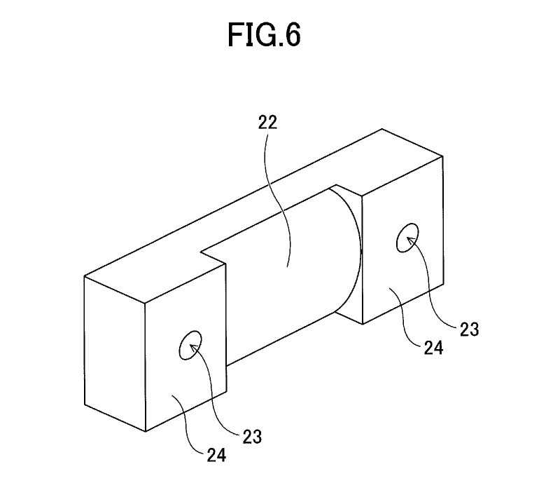

FIGS. 5A, 5B, 5C and 5D are a front view, a plan view, a rear view and a side view, respectively, of the lens part 20. FIG. 5E is a sectional view of the lens part 20, taken along the one-dot chain line 5A-5B of FIG. 5B. FIG. 6 is a rear-side perspective view of the lens part 20.

The lens part 20 is formed by molding a light-transmitting resin material such as COP, using a mold. The refractive index of this resin material is approximately, 1.561.

The lens part 20 includes a front surface 20a and a rear surface 20b on opposite sides of the lens part 20. The front surface 20a includes multiple lenses 21 that form a lens array. The rear surface 20b serves as a connecting surface to connect to the body 10. The rear surface 20b includes a curved surface 22 and flat surfaces 24. The flat surfaces 24 are formed one on each side of the curved surface 22 in a transverse direction of the lens part 20 perpendicular to its front-to-rear direction. The flat surfaces 24 contact the connecting surface 13 of the body 10. The curved surface 22 is in the central area of the rear surface 20b corresponding to the formation area of the lenses 21. Two guide pin holes 23 that pierce through the lens part 20 in its front-to-rear direction are provided one on each transverse side of the curved surface 22. The guide pin holes 23 are open at the flat surfaces 24. The curved surface 22, which is between the flat surfaces 24, is formed by part of a cylindrical surface having a radius of 1.25 mm. Alternatively, the curved surface 22 may be formed by part of a curved surface such as an elliptic cylindrical surface, a hyperbolic cylindrical surface, and a parabolic cylindrical surface. Part of the curved surface 22 projecting most in a rearward direction in which the lens part 20 connects to the body 10 and serving as the generatrix of the cylindrical surface is at substantially the same height from the front surface 20a as and parallel to the two flat surfaces 24. That is, the most projecting part of the curved surface 22 is in substantially the same plane as the flat surfaces 24.

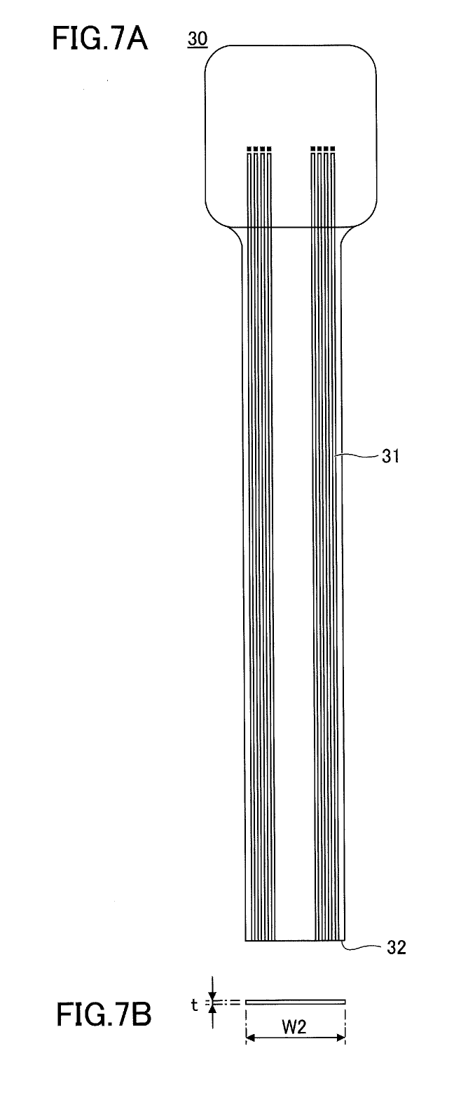

FIGS. 7A and 7B are diagrams illustrating a structure of an optical waveguide 30 employed in this embodiment. Referring to FIGS. 7A and 7B, the optical waveguide 30, which is formed of a resin material, includes cores 31 in which light propagates and cladding that covers the cores 31 from above and below the cores 31. The optical waveguide 30 has a sheet shape. The optical waveguide 30 has an end face 32 formed at one end. The end face 32 connects to the ferrule of this embodiment. In a portion of the optical waveguide 30 near its other end, mirrors for causing light from a light-emitting device to enter the corresponding cores 31 and mirrors for causing light from the corresponding cores 31 to enter a light-receiving device are formed in the cores 31.

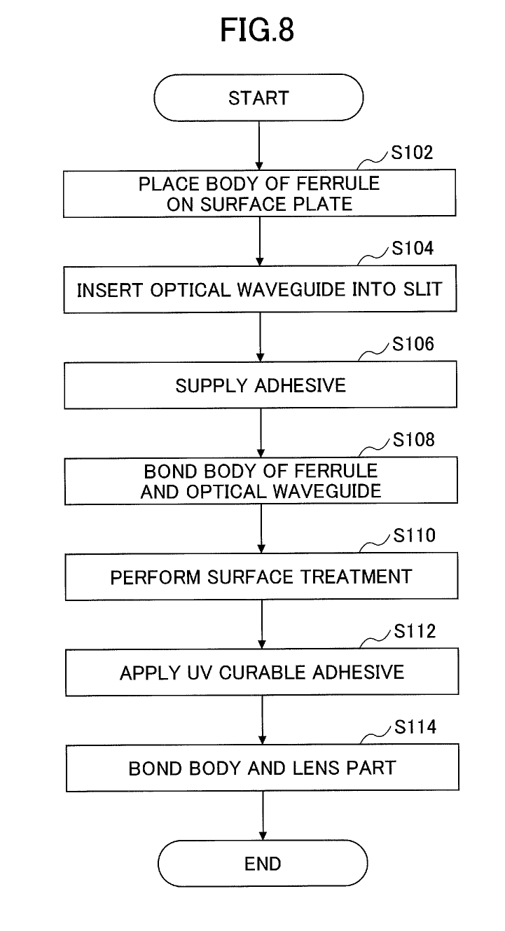

Next, a method of manufacturing a ferrule according to this embodiment is described with reference to the flowchart of FIG. 8.

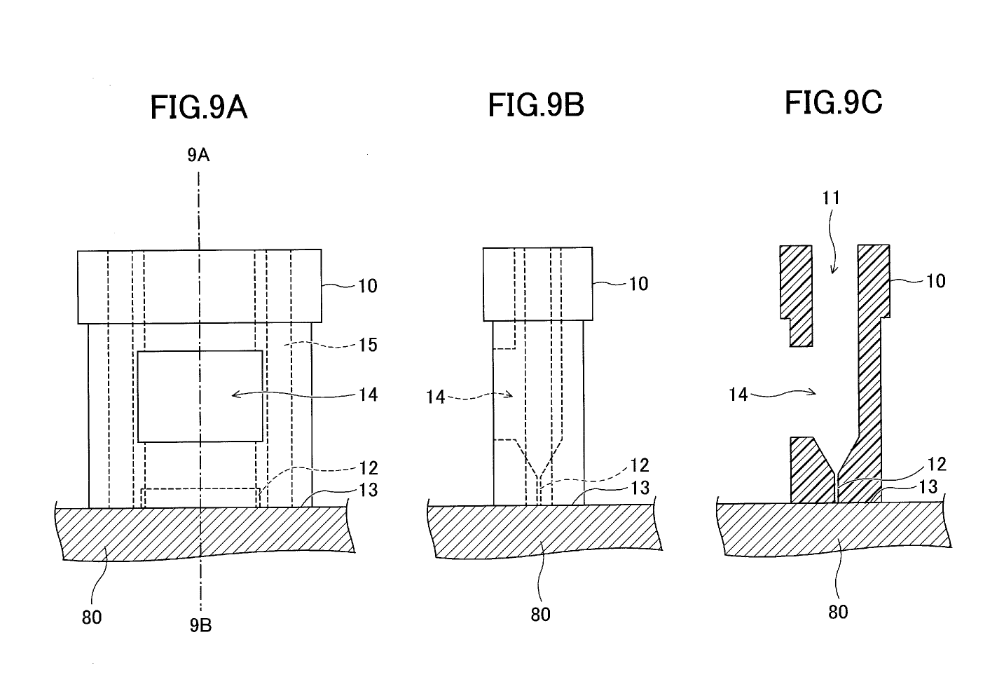

First, at step S102, the body 10 is placed on a surface of a surface plate. Specifically, as illustrated in FIGS. 9A through 9C, the body 10 is placed on a surface plate 80 with the connecting surface 13 contacting a surface of the surface plate 80. The surface plate 80 is formed of a metal material, and the surface of the surface plate is flat. FIGS. 9A and 9B are a plan view and a side view, respectively, of the body 10 placed on the surface plate 80. FIG. 9C is a sectional view of the body 10, taken along the one-dot chain line 9A-9B of FIG. 9A.

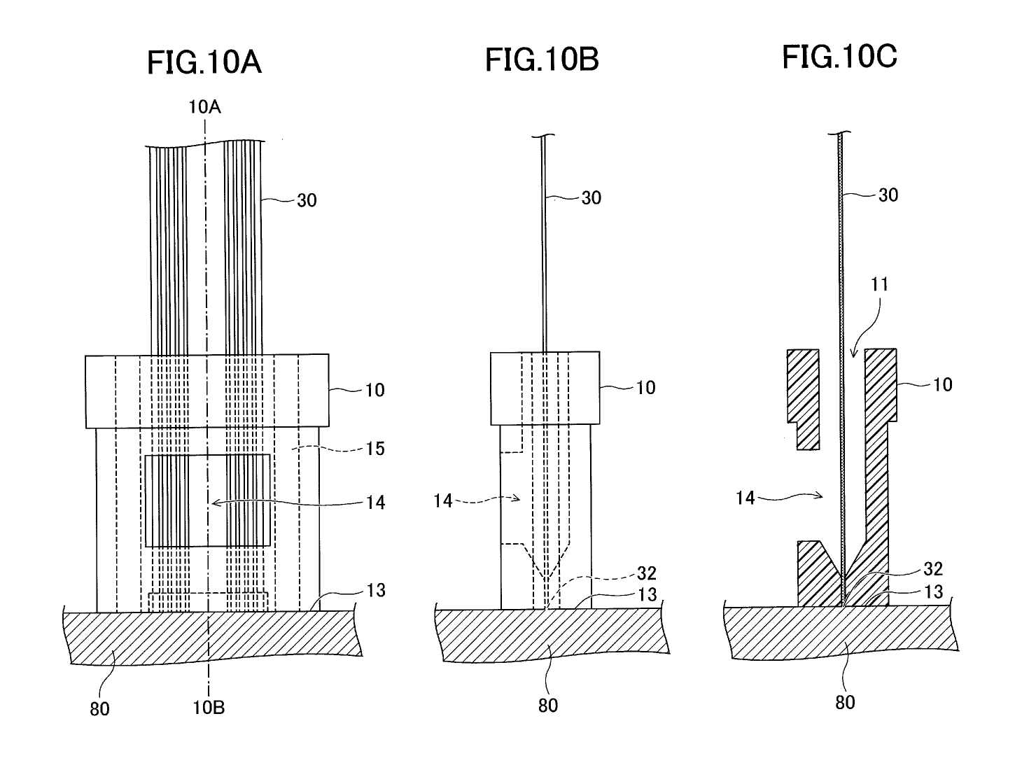

Next, at step S104, the optical waveguide 30 is inserted into the slit 12 through the opening 11. Specifically, as illustrated in FIGS. 10A through 100, the optical waveguide 30 is inserted, with the end face 32 foremost, into the slit 12 through the opening 11. Because the slit 12 penetrates to the connecting surface 13, the optical waveguide 30 can be inserted into the slit 12 until the end face 32 contacts the surface of the surface plate 80. As a result, the connecting surface 13 and the end face 32 are leveled with each other by the surface of the surface plate 80 to be in the same plane. FIGS. 10A and 10B are a plan view and a side view, respectively, of the body 10 into which the optical waveguide 30 is inserted. FIG. 100 is a sectional view of the body 10 into which the optical waveguide 30 is inserted, taken along the one-dot chain line 10A-10B of FIG. 10A.

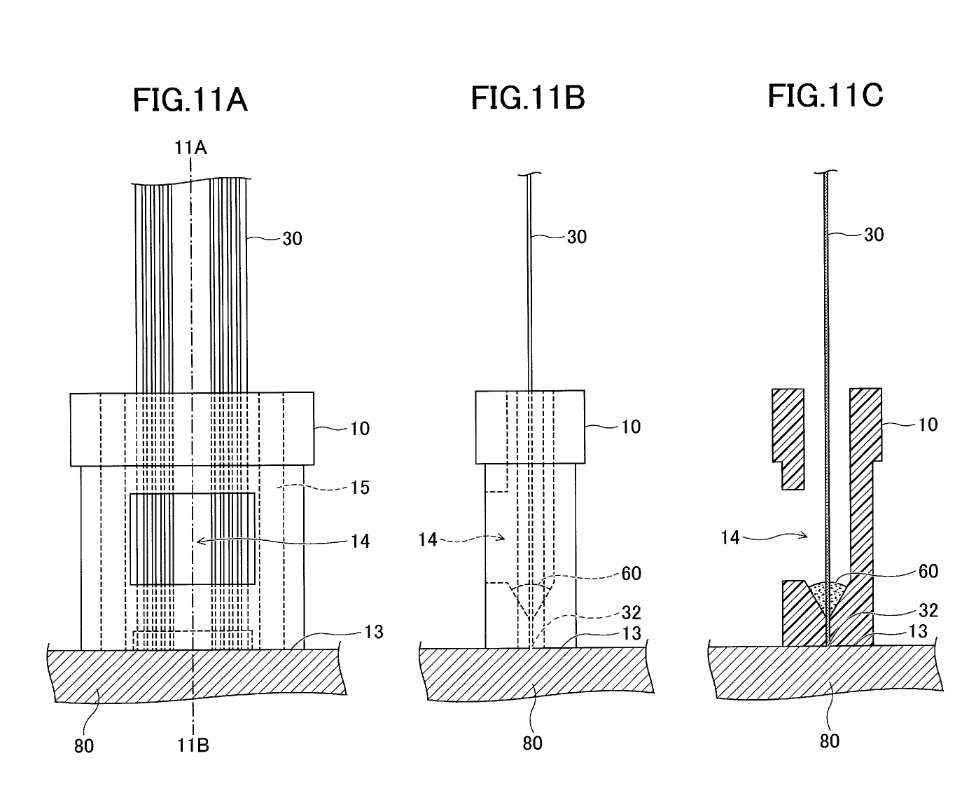

Next, at step S106, an adhesive 60 for bonding the body 10 and the optical waveguide 30 together is supplied. Specifically, as illustrated in FIGS. 11A through 11C, the adhesive 60 is supplied through the window 14 of the body 10 to adhere to each of the body 10 and the optical waveguide 30 at the bottom of the opening 11 from which the slit 12 extends. The adhesive 60 may be either a UV curable adhesive or an adhesive other than a UV curable adhesive, such as an adhesive whose main ingredient is cyanoacrylate. FIGS. 11A and 11B are a plan view and a side view, respectively, of the body 10 to which the optical waveguide 30 is bonded. FIG. 11C is a sectional view of the body 10 to which the optical waveguide 30 is bonded, taken along the one-dot chain line 11A-11B of FIG. 11A.

Next, at step S108, the supplied adhesive 60 is cured to bond the body 10 and the optical waveguide 30 together. Specifically, the body 10 and the optical waveguide 30 are bonded together by curing the adhesive 60 by exposing the adhesive 60 to UV light when the adhesive 60 is a UV curable adhesive and by leaving the adhesive 60 for a predetermined time when the adhesive 60 is an adhesive whose main ingredient is cyanoacrylate. According to embodiments of the present invention, this process may be referred to as “first bonding process.”

Next, at step S110, the connecting surface 13 of the body 10 and the curved surface 22 and the flat surfaces 24 of the lens part 20 are subjected to surface treatment to improve their wettability with respect to an adhesive at the time of its UV curing. Specifically, excimer UV treatment is performed to expose the connecting surface 13, the curved surface 22, and the flat surfaces 24 to excimer UV light. In this treatment, a Xe (xenon) excimer lamp is employed as a light source, and the excimer lamp radiation wavelength is 172 nm. Examples of surface treatment for improving wettability other than excimer UV treatment include plasma processing that performs surface treatment by exposing the connecting surface 13, the curved surface 22, and the flat surfaces 24 to plasma.

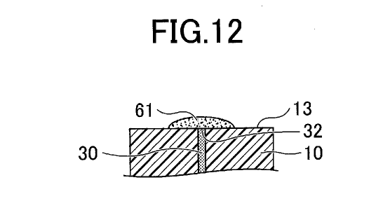

Next, at step S112, an adhesive 61 is applied on the connecting surface 13. Specifically, the adhesive 61, which is defoamed by vacuum treatment or centrifugal separation, is applied on the connecting surface 13 as illustrated in FIG. 12.

Next, at step S114, the connecting surface 13 and the curved surface 22 are bonded together by the adhesive 61. According to embodiments of the present invention, this process may be referred to as “second bonding process.”

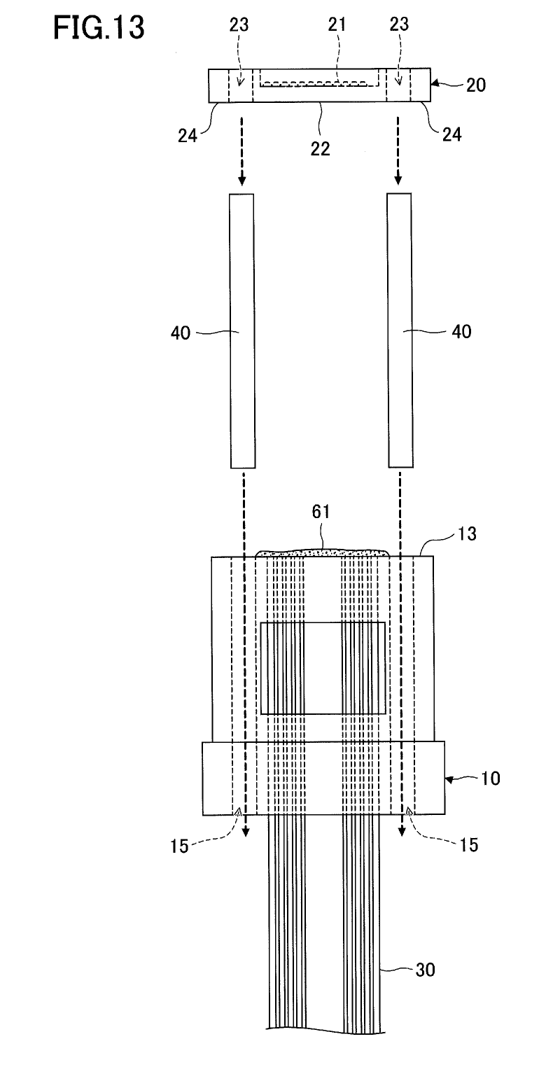

Specifically, as illustrated in FIG. 13, with the connecting surface 13 on which the adhesive 61 is applied and the curved surface 22 being opposed to each other, guide pins 40 are inserted into the guide pin holes 15 of the body 10 and the guide pin holes 23 of the lens part 20, and the body 10 and the lens part 20 are moved toward each other to bring the connecting surface 13 and the curved surface 22 into contact with each other.

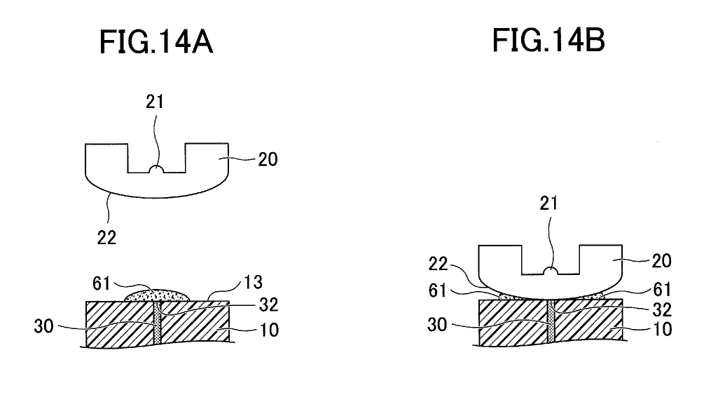

At this point, by moving the body 10 toward the lens part 20 from a position where the connecting surface 13 is distant from the curved surface 22 as illustrated in FIG. 14A, first, the curved surface 22 contacts the adhesive 61 applied on the connecting surface 13. By further moving the body 10 toward the lens part 20, the adhesive 61 is pressed by the curved surface 22 to wet and spread over the connecting surface 13 and the curved surface 22 as illustrated in FIG. 14B. Therefore, even if the adhesive 61 contains air bubbles, the air bubbles move away from the end face 32 of the optical waveguide 30 with the wet spreading of the adhesive 61. Accordingly, no air bubbles are present between the end face 32 and the curved surface 22.

That is, as illustrated in FIG. 14B, the end face 32 of the optical waveguide 30 inserted in the body 10 contacts the curved surface 22 of the lens part 20 through the adhesive 61, and the applied adhesive 61 wets and spreads laterally as depicted on the connecting surface 13 and the curved surface 22 whose wettability is improved by treatment. At this point, the connecting surface 13 comes into contact with part of the curved surface 22 and with the flat surfaces 24. By exposing the UV curable adhesive 61 to UV radiation in this state, the adhesive 61 is cured to bond the body 10 and the lens part 20 together.

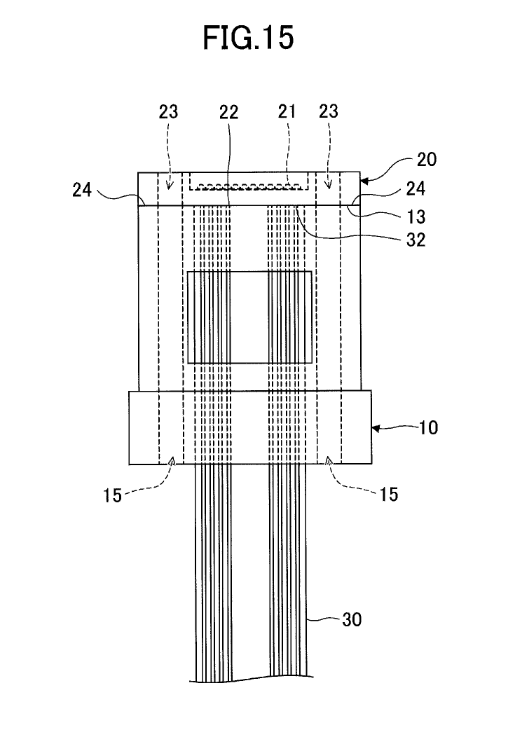

By the above-described process, as illustrated in FIG. 15, a ferrule of this embodiment to which an optical waveguide is bonded can be manufactured. According to this embodiment, there are no air bubbles between the end face 32 of the optical waveguide 30 and the curved surface 22 of the lens part 20. Therefore, there is no degradation of characteristics due to the attenuation of light by air bubbles.

The refractive index of the light-transmitting resin material of the lens part 20 is, for example, 1.561, and an adhesive whose refractive index after curing is close to the refractive index of the resin material of the lens part 20, namely, 1.561, is used as the adhesive 61. Therefore, even if the adhesive 61 remains between the lens part 20 and the end face 32 of the optical waveguide 30, no optical loss is caused at their interface.

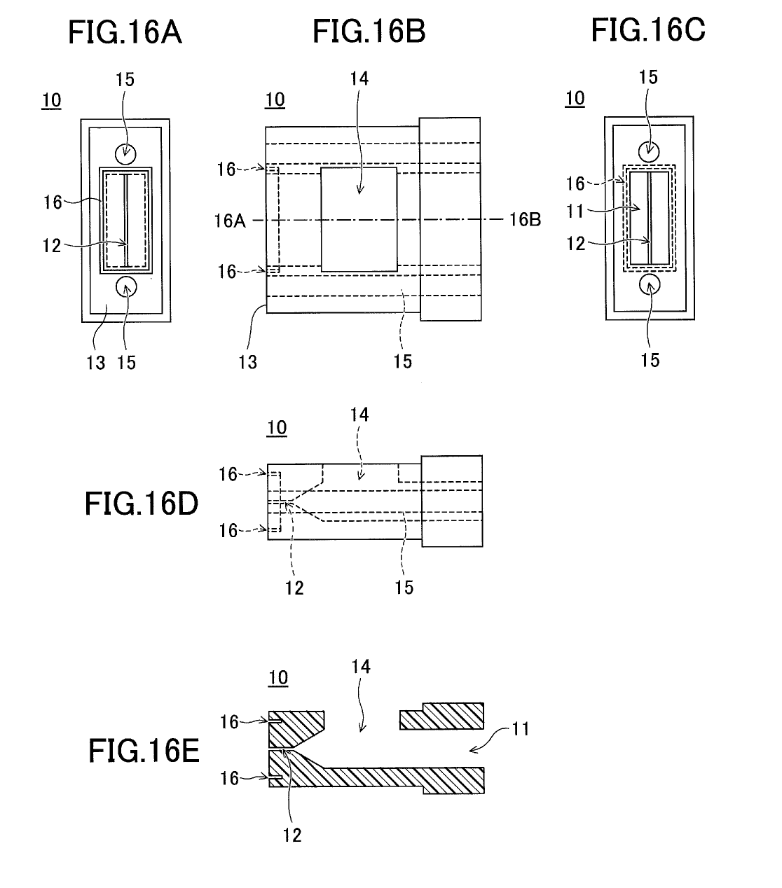

Furthermore, according to this embodiment, as illustrated in FIGS. 16A through 16E, a groove 16 may be provided around the slit 12 in the connecting surface 13. As a result, when the body 10 and the lens part 20 are bonded together using the adhesive 61, the adhesive 61 wets and spreads over the connecting surface 13 to enter the groove 16. Therefore, it is possible to prevent the adhesive 61 from running off to side surfaces of the body 10 and the lens part 20. FIGS. 16A, 16B, 16C and 16D are a front view, a plan view, a rear view and a side view, respectively, of the body 10. FIG. 16E is a sectional view of the body 10, taken along the one-dot chain line 16A-16B of FIG. 16B.

### Second Embodiment

Next, a second embodiment is described. According to this embodiment, a connecting surface of a body includes a curved surface, and a lens part has a flat connecting surface. According to this structure, the same effects as in the first embodiment can be achieved.

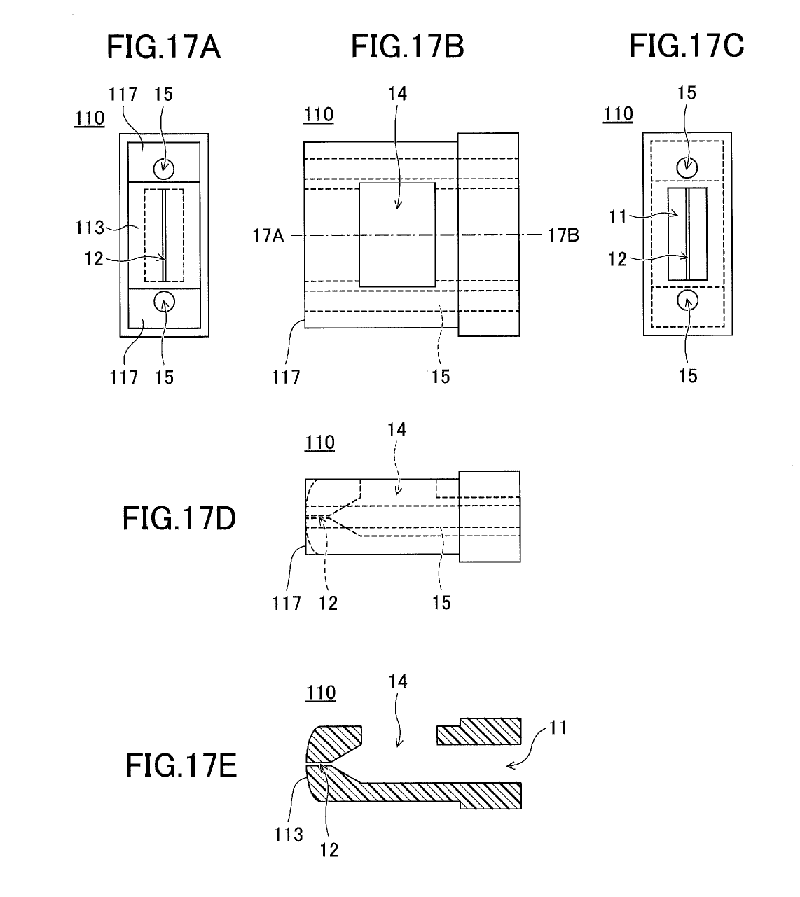

FIGS. 17A, 17B, 17C and 17D are a front view, a plan view, a rear view and a side view, respectively, of a body 110 according to the second embodiment. FIG. 17E is a sectional view of the body 110, taken along the one-dot chain line 17A-17B of FIG. 17B. The body 110 is formed by molding a resin material using a mold.

The opening 11 for inserting an optical waveguide is provided in the body 110. The slit 12 for placing an end face of the optical waveguide is provided at the bottom of the opening 11. A curved surface 113 is formed in an area of the body 110 to serve as a connecting surface to connect to a lens part 120. The slit 12 pierces through the body 110 to the curved surface 113. The window 14 for supplying an adhesive is formed through an upper surface of the body 110.

The two guide pin holes 15 pierce through the body 110 in a longitudinal direction of the body 110. The guide pin holes 15 are open at flat surfaces 117 of the connecting surface.

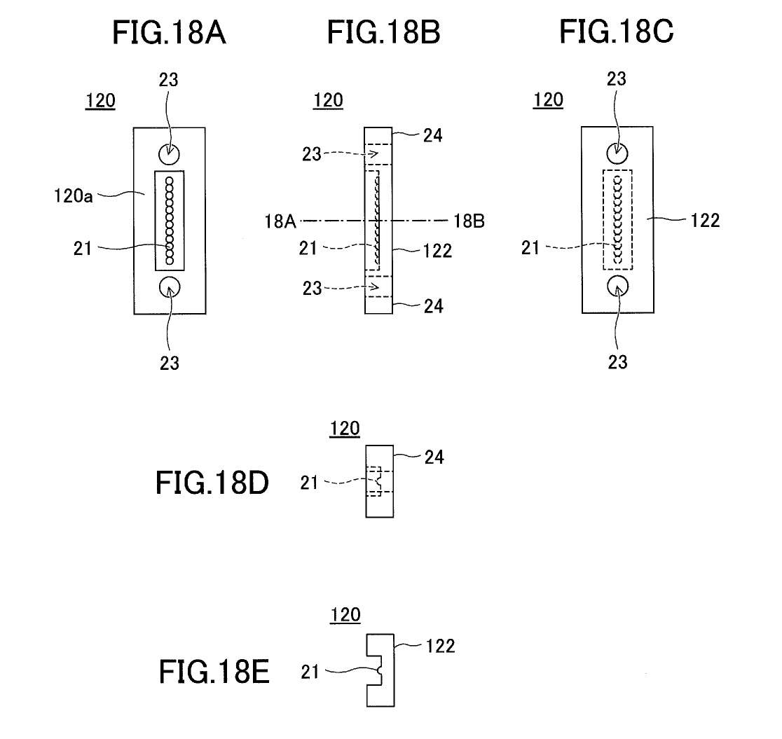

FIGS. 18A, 18B, 18C and 18D are a front view, a plan view, a rear view and a side view, respectively, of the lens part 120. FIG. 18E is a sectional view of the lens part 120, taken along the one-dot chain line 18A-18B of FIG. 18B. The lens part 120 is formed by molding a resin material such as COP, using a mold.

The lens part 120 includes a front surface 120a and a rear surface 122. The front surface 120a includes the lenses 21 that form a lens array. The rear surface 122 is a flat surface that serves as a connecting surface to connect to the body 110. The two guide pin holes 23 that pierce through the lens part 120 in its front-to-rear direction are provided one on each transverse side of the lens array.

The ferrule according to this embodiment, which is manufactured by bonding the body 110 and the lens part 120 together, is manufactured by the same process as that of the method of manufacturing a ferrule according to the first embodiment. Furthermore, according to this embodiment, the connecting surface of the lens part 120 may be a curved surface. That is, each of the body 110 and the lens part 120 may have a curved connecting surface. In other respects than those described above, the second embodiment may be the same as the first embodiment.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority or inferiority of the invention. Although one or more embodiments of the present invention have been described in detail, it should be understood that the various changes, substitutions, and alterations could be made hereto without departing from the spirit and scope of the invention.

What is claimed is:

1. A ferrule comprising:
a body including a first connecting surface at which a slit for inserting an optical waveguide is open; and
a lens part including a lens and a second connecting surface, the lens part being bonded to the body with an adhesive with the second connecting surface facing and contacting the first connecting surface,
wherein at least one of the first connecting surface and the second connecting surface includes a curved surface.

2. The ferrule as claimed in claim 1, wherein the lens and the second connecting surface are on opposite sides of the lens part.

3. The ferrule as claimed in claim 1, wherein the at least one of the first connecting surface and the second connecting surface further includes a plurality of flat surfaces one on each of sides of the curved surface in a transverse direction perpendicular to a longitudinal direction of the ferrule.

4. The ferrule as claimed in claim 3, wherein a part of the curved surface is in substantially a same plane as the plurality of flat surfaces.

5. A method of manufacturing a ferrule including a body and a lens part, the body including a first connecting surface at which a slit for inserting an optical waveguide is open, the lens part including a lens and a second connecting surface, wherein at least one of the first connecting surface and the second connecting surface includes a curved surface, the method comprising:
inserting the optical waveguide into the slit of the body;
leveling an end face of the optical waveguide with the first connecting surface;
bonding the optical waveguide and the body together;
and bonding the first connecting surface and the second connecting surface together with an adhesive.

6. The method as claimed in claim 5, further comprising:
subjecting one or both of the first connecting surface and the second connecting surface to treatment for improving wettability of the one or both of the first connecting surface and the second connecting surface with respect to the adhesive, before said bonding the first connecting surface and the second connecting surface.
